(19) United States
(12) Patent Application Publication
(10) Pub. No.: US 2024/0326291 A1
(43) Pub. Date: Oct. 3, 2024

(54) DEVICE AND METHOD FOR PROCESSING PLASTIC MATERIAL

(71) Applicant: Coperion GmbH, Stuttgart (DE)

(72) Inventors: Leonid LIBER, Rutesheim (DE); Jochen SCHOFER, Stuttgart (DE); Felix DREHER, Stuttgart (DE); Marina MATTA, Gemmingen (DE); Aleyna YAMAN, Ravensburg (DE)

(73) Assignee: Coperion GmbH, Stuttgart (DE)

(21) Appl. No.: 18/618,686

(22) Filed: Mar. 27, 2024

(30) Foreign Application Priority Data
Mar. 29, 2023 (EP) 23 164 886.6

(51) Int. Cl. B29B 7/42; B29B 7/84; B29B 7/88; B29B 13/10

(52) U.S. Cl. CPC B29B 7/42; B29B 7/84; B29B 7/88; B29B 13/10

(57) ABSTRACT

A device for processing plastics material, comprising: a screw machine having at least one treatment element shaft for plasticizing the plastics material, stored in a housing, to form a polymer melt, wherein the screw machine has a plasticizing zone, a compounding zone, and an accumulation zone arranged between the plasticizing zone and the compounding zone, having at least one accumulation element which holds the polymer melt, at least one melt channel which bridges the accumulation zone and connects the plasticizing zone and the compounding zone to one another.

### CROSS-REFERENCED TO RELATED APPLICATION

This application claims priority to European Application No. 23 164 886.6 filed on Mar. 29, 2023, the entire contents of which are hereby incorporated by reference.

### TECHNICAL FIELD

The disclosure relates to a method for processing plastics material, in particular thermoplastic material, such as plastics recycling material and/or plastics waste. The disclosure also relates to a method for processing plastic material, such as plastics material recycling material and/or plastic waste.

### BACKGROUND

Plastic recycling material, such as for example post-consumer waste, represents an important raw material source. In the case of plastic recycling material, however, the plastics are usually contaminated, for example with biomass, sand, paper, glass, aluminum, and similar. For economically reasonable use, the plastics material recycling material has to be sorted from the impurities, for example by washing, and shredded. A further processing can then take place using extrusion lines. The processed plastic material can then be processed into granules using a granulation system, which represents valuable, high-quality starting material for new products.

### SUMMARY

During mechanical recycling, the plastics material recycling material is usually melted by means of a first extruder system and the polymer melt is supplied to a filtration and granulation system. A second extruder system is then charged with the plastic granulate in which it remelted, then compounding and degassed and then regranulated. New products can then be made from the regranulates obtained. Due to twice melting, such systems are extremely energy-efficient and cost-intensive.

However, it would be desirable for the filtration and compounding to take place more efficiently and more economically during plastic recycling in order to save energy and costs.

The disclosure is based on the object of structurally and/or functionally improving a device mentioned above for processing plastic material. The disclosure is also based on the object of structurally and/or functionally improving a method for processing plastic material mentioned above. It is therefore an object of embodiments of the present disclosure to provide a processing device and a processing method which reduce or eliminate the problems identified in connection with the prior art. For example, it is an object to increase energy efficiency and reduce costs for operations, logistics, etc.

The object is achieved with a device having the features of claim 1. The object is further achieved by a method having the features of claim 10. Advantageous embodiments and/or further embodiments are the subject matter of the subclaims, the description and/or the accompanying figures. Particularly, the independent claims of one category of claims may also be further defined and/or combined analogously to the dependent claims of another category of claims. The device and method features described below can also be combined with one another and/or further developed.

One aspect relates to a device for processing plastic material. The device can be a processing plant.

The plastics material can be or comprise plastics material recycling material. The plastics material recycling material can be plastic waste, e.g., final consumer plastic waste (“post-consumer waste”). In embodiments, the recycled plastic material is in the form of plastic particles, which can be washed and/or cleaned. Depending on the particle size and/or particle shape, the plastic particles can be in the form of plastic granules, plastic flakes, plastic fibers or plastic powder, for example. The plastic particles can be recycled. The plastic particles can also be flake-shaped and/or flat-shaped. The plastics material recycling material may also have been shredded or ground. In particular, the plastics material recycling material or the plastic particles forms bulk material. The plastic material can in particular have thermoplastic polymers.

In embodiments, the device comprises a screw machine with at least one treatment element shaft mounted in a housing for plasticizing the supplied plastic material to form a polymer melt. The at least one treatment element shaft can be designed to plasticize and/or prepare the polymer melt. The housing can be a cylinder housing in which the at least one treatment element shaft is accommodated.

For feeding the plastic material into the screw machine, the screw machine can have a feed opening. In embodiments, the feed opening can be provided in an intake zone of the screw machine. In one variant, the feed opening can be a main feed opening, e.g. main inlet, of the screw machine. The device can furthermore comprise a feed device and/or metering device for supplying the plastics material. The plastic material can be supplied, for example, continuously and/or in a metered manner. Alternatively, the plastic material can be supplied discontinuously.

The screw machine can have a plasticizing zone, a compounding zone and an accumulation zone arranged between the plasticizing zone and the compounding zone. The plasticizing zone of the compounding zone can be directly or directly upstream, and the compounding zone can be immediately or directly downstream of the accumulation zone. The accumulation zone can, for example, have at least one accumulation element which impress the plastics material melt. The at least one accumulation element can be arranged in the housing. For example, the at least one accumulation element can be formed and/or arranged on or on the at least one treatment element shaft.

The device can furthermore have at least one melt channel bridging the accumulation zone, which melt channel connects the plasticizing zone and the compounding zone to one another. The device can thus be designed to guide the polymer melt from the plasticizing zone through the melt channel into the compounding zone.

According to a variant, the device can have at least one melt filter device for filtering the polymer melt. The at least one melt filter device can be effectively arranged in the melt channel. For example, a melt channel portion can guide into the melt filter device or be connected to an inlet of the melt filter device. Furthermore, a further melt channel portion can be connected at an outlet of the melt filter device. In the housing of the screw machine, a housing can be provided directly before the accumulation zone in the melt channel leading to the melt filter device. Furthermore, an inlet of the melt channel coming from the melt filter device can be provided in the housing of the screw machine immediately after the accumulation zone. A melt channel portion can therefore be connected with its one end to the outlet in the housing and with its other end to the inlet of the melt filter device. A further melt channel portion can be connected with its one end to the outlet of the melt filter device and with its other end to the inlet in the housing. Both the outlet and the inlet can be an opening in the housing from which the polymer melt can be led out of the screw machine or can be re-inserted into the screw machine.

The at least one melt filter device can have at least one melt filter. The at least one melt filter can be operable continuously or discontinuously. The melt filter can have one or more filter units with a filter element. The filter element can be, for example, a filter screen and/or filter cylinder which is designed to filter the polymer melt. In one embodiment variant, the at least one melt filter device can have a pressure build-up unit for building up a melt pressure. The pressure build-up unit can be, for example, a melt pump and/or gear pump. The pressure build-up unit can be upstream of the melt filter, for example in such a way that the pressure build-up unit can press the polymer melt at a certain melt pressure through the melt filter.

In one embodiment variant, the compounding zone can have a feed portion for supplying at least one additive into the screw machine. The feed portion can be a feed zone. The additive may be or include an additive, excipient, filler, talc, stabilizer, modifier, impact modifier, antioxidant, dye or water. For example, the additive can be powdered, granulated, fibrous or liquid. The additive can also be present as hollow spheres. By adding at least one additive, the plastic properties and/or the plastic structure can be changed and/or adjusted in a targeted manner. At least one feed opening can be provided in the feed portion for feeding the additive. In one variant, the device can have at least one feed device and/or metering device for feeding the at least one additive into the polymer melt. The additive may be added continuously and/or metered. Alternatively, the additive can be supplied discontinuously. The feed device can, for example, be or comprise a feed screw machine, in particular a two-shaft side feeder screw machine, for example. Furthermore, the compounding zone can have a mixing portion downstream of the feed portion in the conveying direction for melting the additive and/or mixing the additive into the polymer melt. The mixing portion can be a mixing zone. In the compounding zone, the at least one additive can therefore be added and/or mixed after the polymer melt has been filtered. It is advantageous that the filtering of the polymer melt and subsequent compounding can take place by means of a single screw machine.

In addition, at least one degassing opening for degassing can be provided in the housing of the screw machine. The at least one degassing opening can be arranged in the intake zone, the plasticizing zone, the accumulation zone, the compounding zone or a discharge zone of the screw machine. For example, the at least one degassing opening can be connected to a degassing device, for example a vacuum degassing device. Alternatively, the at least one degassing opening can be designed for degassing and/or venting with respect to the atmosphere. A plurality of degassing openings can also be provided, for example in all or different zones of the screw machine.

The screw machine can be a single-shaft screw machine with a treatment element shaft, for example a single-screw extruder. In an embodiment variant, the screw machine can be a multi-shaft screw machine, for example a twin-shaft screw machine. The screw machine can be designed as a multi-shaft screw machine which is rotationally driven and/or in the opposite direction in the same direction. For example, the screw machine can have two treatment element shafts which are rotatably mounted in the housing. The two-shaft screw machine can in particular be a twin-screw extruder. The at least one treatment element shaft can be an extruder screw. The plasticizing and/or preparation can take place by means of the treatment element shafts of the screw machine.

A discharge opening can be provided on a last housing portion of the housing in the conveying direction. The compounded or prepared plastic melt can be discharged through the discharge opening. An extrusion tool, a strand head tool, a nozzle device or a screw machine can be connected to the discharge opening. Alternatively, a filter device and/or a granulating device or another further processing system can be connected to the discharge opening.

A further aspect relates to a method for processing plastics material, in particular the plastics material described above and/or below. The plastic material can therefore be, for example, plastic recycling material. The method can be a processing method. The method can furthermore be carried out with the device described above and/or below.

In the method, the plastic material can first be fed into a screw machine. At least one additive can be added to the plastics material. The plastic material can be fed in, for example, by means of a feed device and/or metering device. The plastic material can be supplied continuously and/or in a metered manner. Alternatively, the plastic material can be supplied discontinuously. For example, the plastic material can be fed via a feed opening of the screw machine. In one variant, the feed opening can be a main feed opening, e.g. main inlet, of the screw machine.

The fed plastics material can then be plasticized to form a polymer melt by means of the screw machine. Plasticizing can be understood as melting the plastic material. In one variant, at least one additive can be mixed into the polymer melt during the plasticizing. The plasticizing can take place and/or the screw machine can be controlled such that a certain melt temperature can be reached and/or maintained. The plasticizing can take place by means of at least one treatment element shaft of the screw machine, for example in the plasticizing zone of the screw machine. In an embodiment variant, the plasticizing can take place by means of two treatment element shafts of the screw machine.

In the method, at least a part of the polymer melt can be guided out of the screw machine. For example, the polymer melt can be led out of the screw machine completely and/or continuously. The polymer melt led out can then be filtered by means of a melt filter device. The filtered polymer melt can then be returned to the screw machine.

The polymer melt can be compounded and/or prepared. The recycled and/or filtered polymer melt can be compounded and/or prepared by means of the screw machine. At least one additive can be added to the polymer melt. For this purpose, the additive can be supplied to the screw machine. At least one additive can therefore be mixed into the polymer melt during compounding, in particular in order to selectively modify and/or adjust the plastic properties and/or plastic structure. The additive may be added continuously and/or metered. Alternatively, the additive can be supplied discontinuously. For example, the additive can be supplied via a feed opening of the screw machine. In one variant, the additive can be supplied by means of a feed device and/or metering device.

It is particularly advantageous that the addition and/or mixing of the at least one additive can take place after the polymer melt has been filtered. According to embodiments, the filtering of the polymer melt and subsequent compounding can therefore take place by means of a single screw machine.

In a further embodiment variant, the polymer melt can be homogenized and/or degassed. The degassing can take place, for example, via a degassing opening and/or with a degassing device. Furthermore, the degassing can take place in the feed zone, the plasticizing zone, the accumulation zone, the compounding zone and/or the discharge zone of the screw machine.

The prepared or compounded and/or degassed polymer melt can then be discharged from the screw machine. The compounded polymer melt discharged from the screw machine can then be filtered by means of a filter device and/or granulated by means of a granulating device. Alternatively, the compounded plastic melt discharged from the screw machine can be supplied to an extrusion tool, an extruded head tool, a nozzle device, a screw machine or another further processing system.

In summary and in other words, embodiments thus result in a device, such as an extrusion installation, which comprises only one screw machine, such as extruder, for filtration and compounding of plastic melts. The plastic material can be melted in the screw machine, the contaminated polymer melt for filtration can be conducted out of the screw machine and then returned to the same screw machine for compounding and/or degassing. The device and/or the screw machine can also be referred to as filtration compound, wherein the melting, filtering and filling/compounding of the polymer melt can take place by means of a single extruder.

Embodiments can significantly increase the energy efficiency, in particular in that the plastic material has to be melted only once. The costs for the operation of the system and for logistics can also be reduced. A smaller footprint by less extruder and granulating technology can be made possible. Furthermore, the complexity of the system can be reduced.

### BRIEF DESCRIPTION OF THE DRAWINGS

Exemplary embodiments are described in more detail below with reference to figures, in which the following are shown schematically and by way of example:

FIG. 1 shows a partially sectional view of a device for processing plastic material.

### DETAILED DESCRIPTION

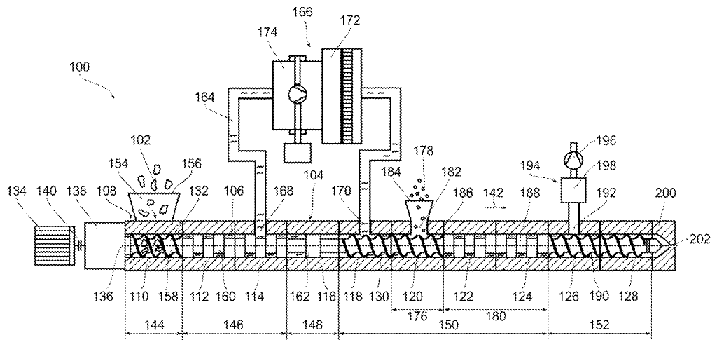

FIG. 1 shows a processing device 100 for processing plastics material recycling material 102. The processing device 100 comprises a multi-shaft screw machine 104 and serves to plasticize the plastics material recycling material 102 to form a polymer melt 106, for filtering the melted polymer melt 106 and the subsequent processing or compounding of the polymer melt 106.

The multi-shaft screw machine 104 is designed as a unidirectional twin-shaft screw machine. The multi-shaft screw machine 104 comprises a housing 108 made of a plurality of successively arranged housing portions 110 to 128, which are connected to one another to form the housing 108. Two housing bores 130 which are parallel to one another and penetrate one another are formed in the housing 108 and have the shape of a lying eight in cross section. The multi-shaft screw machine 104 further comprises two treatment element shafts 132 arranged concentrically in the housing bores 130, which can be rotationally driven by a drive motor 134 about associated rotational axes 136. A branch gear 138 and a clutch 140 are arranged between the treatment element shafts 132 and the drive motor 134. By means of the drive motor 134, the two treatment element shafts 132 are rotationally driven in the same direction, i.e. in the same directions of rotation, about the axes of rotation 136. The treatment element shafts 132 are designed to plasticize the supplied plastics material recycling material 102 to form the polymer melt 106 and to prepare or compounding the polymer melt 106.

As shown in FIG. 1, in a conveying direction 142, the multi-shaft screw machine 104 has one intake zone 144, a plasticizing zone 146, an accumulation zone 148, a compounding zone 150, and a discharge zone 152.

In the intake zone 144, the housing portion 110 has a supply opening 154 with a main inlet funnel 156 for feeding the plastics material recycling material 102 into the multi-shaft screw machine 104. In the feed zone 144, the treatment element shafts 132 comprise screw elements 158 for conveying the plastics material recycling material 102 in the conveying direction 142.

A melting of the plastics material recycling material 102 takes place in the plasticizing zone 146. For melting, the treatment element shafts 132 have kneading elements 160 designed as kneading discs in the plasticizing zone 146. In the plasticizing zone 146, the plastics material recycling material 102 is melted to form the polymer melt 106. In addition, the polymer melt 106 can be homogenized in the plasticizing zone 146.

The accumulation zone 148 is arranged between the plasticizing zone 146 and the compounding zone 150. A build-up of the polymer melt 106 takes place in the accumulation zone 148. For this purpose, the treatment element shafts 132 have an accumulation element 162 in the accumulation zone 148, for example a baffle plate. As a result of the accumulation, the polymer melt 106 is pressed back substantially counter to the conveying direction 142. The processing device 100 furthermore has a melt channel 164 which bridges the accumulation zone 148 and connects the plasticizing zone 146 and the compounding zone 150 to one another. A melt filter device 166 for filtering the polymer melt 106 is effectively arranged in the melt channel 164. The polymer melt 106 pressed back through the accumulation element 162 is pressed through an outlet 168 present in the housing 108 directly upstream of the storage zone 148 into the melt channel 164 leading to the melt filter device 166.

The melt filter device 166 has a melt filter 172 that can be operated continuously or discontinuously. The melt filter 172 can comprise one or more filter elements which are designed to filter the polymer melt 106. Furthermore, the melt filter device 166 has a pressure build-up unit 174 designed as a melt pump for building up a melt pressure. By means of the pressure build-up unit 174, the polymer melt 106 can be pressed by the melt filter 172 at a certain pressure.

After the polymer melt 106 has been filtered through the melt filter device 166, it is returned to the multi-shaft screw machine 104 by an inlet 170 of the melt channel 164 coming from the melt filter device 166 directly after the accumulation zone 148, wherein the filtered polymer melt 106 then passes into the compounding zone 150.

The compounding zone 150 has a feed portion or a feed zone 176 for supplying at least one additive 178 into the multi-shaft screw machine 104 and a mixing portion downstream of the feed zone 176 in the conveying direction 142, or a mixing zone 180 for melting the additive 178 and/or mixing the additive 178 into the polymer melt 106.

In the feed zone 176 of the compounding zone 150, the recirculated, filtered polymer melt 106 is supplied to the at least one additive 178. The additive 178 can be, for example, an additive, modifiers, such as impact modifiers, antioxidant, dye or water. By adding an additive 178, the plastic properties and/or the plastic structure can be adjusted in a targeted manner. A feed opening 182, into which a feed funnel 184 opens, is formed for this purpose in the housing portion 120. The additive 178 is supplied, for example, with a metering device in the feed funnel 184 and/or via a feed screw machine (not shown in FIG. 1) into the multi-shaft screw machine 104. In the feed zone 176, the treatment element shafts 132 have screw elements 186, for example conveying screw elements for conveying the polymer melt 106 and the at least one additive 178 in the conveying direction 142.

In the mixing zone 180 of the compounding zone 150, the at least one additive 178 is melted and/or mixed into the polymer melt 106. The mixture can thereby be homogenized. The treatment element shafts 132 have kneading elements 188 designed as kneading discs in the mixing zone 180.

In the discharge zone 152, the treatment element shafts 132 have conveying screw elements 190 for discharging the processed or compounded polymer melt 106. Furthermore, a degassing opening 192 for degassing the polymer melt 106 is formed in the housing portion 126. The degassing opening 192 is connected to a vacuum degassing device 194, so that the polymer melt 106 is degassed via the degassing opening 192 by means of the vacuum degassing device 194. The vacuum degassing device 194 comprises a vacuum pump 196 which is connected to the degassing opening 192 via a separator 198. Alternatively, the degassing opening 192 can be designed for degassing and/or venting with respect to atmosphere. A nozzle plate 200 which seals the housing 108 and forms a discharge opening 202 is arranged on the last housing portion 128. The filtered and compounded polymer melt 106 can be applied through the discharge opening 202. A filter device and/or granulating device or another further processing system can be connected to the discharge opening 202 (not shown in detail in FIG. 1).

The processing device 100 or its multi-shaft screw machine 104 is in particular designed to filter the polymer melt 106 and then to compounding it in the same multi-shaft screw machine 104. The melting, filtering and filling/compounding of the polymer melt 106 can thus take place by means of a single extruder. The energy efficiency is thereby significantly improved and the operating costs are reduced.

The processing of the plastics material recycling material 102 or the processing method by means of the processing device 100 is described below.

The plastics material recycling material 102 is fed, for example by means of a feed device and/or via the main inlet funnel 156, into the multi-shaft screw machine 104 and then passes into the intake zone 144. In the feed zone 144, the plastics material recycling material 102 is conveyed in the conveying direction 142 to the plasticizing zone 146. The supplied plastics material recycling material 102 is then melted in the plasticizing zone 146 by means of the treatment element shafts 132 or the kneading elements 160 thereof.

Immediately before the accumulation zone 148, at least a part of the polymer melt 106 is led out of the multi-shaft screw machine 104 and then filtered by means of the melt filter device 166. The filtered polymer melt 106 is then returned to the multi-shaft screw machine 104, where it passes into the compounding zone 150.

In the compounding zone 150, the filtered polymer melt 106 is compounded by means of the multi-shaft screw machine 104. At least one additive 178, such as an additive, modifier, antioxidant, or water, which is supplied to the polymer melt 106, is thereby supplied in the feed zone 176 via the feed opening 182. In the mixing zone 180, the at least one additive 178 is melted and mixed into the polymer melt 106. The mixture can also be homogenized here. The addition and/or mixing of the at least one additive 178 thus takes place after the polymer melt 106 has been filtered. Gases escaping from the polymer melt 106 are discharged in the discharge zone 152 by means of the vacuum degassing device 194. Subsequently, the filtered and compounded polymer melt 106 is discharged from the multi-shaft screw machine 104.

The discharged polymer melt 106 can then be supplied to a filter device and/or a granulating device which filters or granulated the polymer melt 106. Alternatively, the discharged polymer melt 106 can be supplied to an extrusion tool, an extruded head tool, a nozzle device or another screw machine.

The term “may” refers in particular to optional features. Accordingly, there are also developments and/or exemplary embodiments which additionally or alternatively have the respective feature or the respective features.

From the feature combinations disclosed in herein, isolated features may also be singled out as required and, by resolving an optionally existing structural and/or functional relationship between the features in combination with other features, be used to delimit the subject matter of the claim. The order and/or number of method steps may be varied.

### REFERENCE SIGNS

100 Processing device
102 Plastic recycling material
104 Multi-shaft screw machine
106 Polymer melt
108 Housing
110-128 Housing portions
130 Housing bores
132 Treatment element shafts
134 Drive motor
136 Rotational axes
138 Branch gear
140 Coupling
142 Conveying direction
144 Feed zone
146 Plasticizing zone
148 Accumulation zone
150 Compounding zone
152 Discharge zone
154 Feed opening
156 Main inlet funnel
158 Conveyor screw elements
160 Kneading elements
162 Accumulation element
164 Melt channel
166 Melt filter device
168 Outlet
170 Inlet
172 Melt filter
174 Pressure build-up unit
176 Feed zone
178 Additive
180 Mixing zone
182 Feed opening
184 Feed funnel
186 Conveyor screw elements
188 Kneading elements
190 Conveyor screw elements
192 Degassing opening
194 Vacuum degassing device
196 Vacuum pump
198 Separator
200 Nozzle plate
202 Discharge opening

What is claimed is:

1. A device for processing plastics material, comprising:
a screw machine having at least one treatment element shaft for plasticizing the plastics material, stored in a housing, to form a polymer melt, wherein the screw machine has a plasticizing zone, a compounding zone, and an accumulation zone arranged between the plasticizing zone and the compounding zone, having at least one accumulation element which holds the polymer melt, at least one melt channel which bridges the accumulation zone and connects the plasticizing zone and the compounding zone to one another, and
at least one melt filter device for filtering the polymer melt which is arranged in the melt channel.

2. The device according to claim 1, wherein an outlet in the melt channel leading to the melt filter device is provided in the housing immediately before the accumulation zone, and in that an inlet of the melt channel coming from the melt filter device is provided in the housing immediately after the accumulation zone.

3. The device according to claim 1, wherein the at least one melt filter device has a melt filter that can be operated continuously or discontinuously.

4. The device according to claim 1, wherein the at least one melt filter device has a pressure build-up unit for building up a melt pressure, in particular a melt pump.

5. The device according to claim 1, wherein the compounding zone has a feed portion for feeding at least one additive into the screw machine and a mixing portion downstream of the feed portion in the conveying direction for melting the additive and/or mixing the additive into the polymer melt.

6. The device according to claim 1, wherein at least one degassing opening is provided in the housing for degassing, wherein the at least one degassing opening is arranged in a feed zone, the plasticizing zone, the storage zone, the compounding zone, or a discharge zone of the screw machine.

7. The device according to claim 6, wherein the at least one degassing opening is connected to a degassing device, in particular a vacuum degassing device, or in that the at least one degassing opening is designed for degassing and/or venting with respect to the atmosphere.

8. The device according to claim 1, wherein the screw machine is a multi-screw machine, in particular a two-screw machine, such as a twin-screw extruder.

9. The device according to claim 1, wherein a discharge opening is provided on a last housing portion of the housing in the conveying direction, through which opening the compounded polymer melt can be applied, wherein an extrusion tool, an extruded head tool, a nozzle device or a screw machine is connected to the discharge opening, or wherein a filter device and/or a granulating device is connected to the discharge opening.

10. A method for processing plastics material, comprising the following steps:
feeding the plastics material into a screw machine;
plasticizing the plastics material by means of the screw machine to form a polymer melt;
conducting at least a part of the polymer melt from the screw machine,
filtering the discharged polymer melt by means of a melt filter device, and returning the filtered polymer melt into the screw machine; and
compounding the polymer melt by means of the screw machine.

11. The method according to claim 10, wherein at least one additive is added to the plastics material and/or the polymer melt, and/or in that at least one additive is mixed into the polymer melt during the plasticizing and/or during compounding.

12. The method according to claim 11, wherein the at least one additive is added and/or mixed after the polymer melt has been filtered.

13. The method according to claim 10, wherein the polymer melt is homogenized and/or degassed.

14. The method according to claim 10, wherein the compounded polymer melt is discharged from the screw machine and then filtered by means of a filter device and/or granulated by means of a granulating device.

15. The method according to claim 10, wherein the compounded polymer melt is discharged from the screw machine and is then supplied to an extrusion tool, an extruded head tool, a nozzle device, or a screw machine.
